(19) United States
(12) Patent Application Publication
(10) Pub. No.: US 2006/0288203 A1
(43) Pub. Date: Dec. 21, 2006

(54) Information processing apparatus and controlling method thereof

(75) Inventor: Kazuki Iwata, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/358,071

(22) Filed: Feb. 22, 2006

(30) Foreign Application Priority Data
Jun. 17, 2005 (JP) 2005-178140

(51) Int. Cl. H04L 9/00

(52) U.S. Cl. 713/151

(57) ABSTRACT

According to one embodiment, an information processing apparatus of the present invention comprises a Root Complex and a graphics controller (End Point). Packet data transmitted and received between the Root Complex and the graphics controller (End Point) are monitored. If it is determined that the packet data are TLP, the packet data are encrypted and decrypted by encryption and decryption circuits and then transmitted and received.

### CROSS-REFERENCE TO RELATED APPLICATIONS

This application is based upon and claims the benefit of priority from prior Japanese Patent Application No. 2005-178140, filed Jun. 17, 2005, the entire contents of which are incorporated herein by reference.

### BACKGROUND

1. Field

This invention relates to an information processing apparatus such as a computer and a method of controlling operations of the apparatus.

2. Description of the Related Art

Recently, a third-generation general-use I/O interconnection interface called PCI Express, for an information processing apparatus such as a computer has been noticed. PCI Express is a standard for making interconnection between devices via a communication path called a Link and is defined by PCI SIG (Peripheral Component Interconnect Special Interest Group). By the PCI Express standard, data transmission between the devices is executed by using packets.

By the technology defined by PCI Express Base Specification Revision 1.1, however, a format of packets (Ordered-set/DLLP/TLP) transmitted and received between devices is defined, but data security (data encryption) is not defined.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an illustration showing an information processing apparatus according to a first embodiment of the present invention according to a first embodiment of the invention;

FIG. 2 is a block diagram showing a system configuration of a computer according to the first embodiment;

FIG. 3 is an illustration showing a connection of two devices each based on the PCI Express standard according to the first embodiment;

FIG. 4 is an illustration showing configurations of a Root Complex and a graphics controller (End Point) each comprising an encryption circuit and a decryption circuit according to the first embodiment;

FIG. 5 is a flowchart showing a processing for initializing authentication of the encryption and decryption circuits 30, 32, 34 and 36 according to the first embodiment;

FIG. 6 is an illustration showing management packets used for encryption and decryption according to the first embodiment;

FIG. 7 is a flowchart showing a processing executed after the authentication of the encryption/decryption circuits 30, 32, 34 and 36 is completed according to the first embodiment;

FIG. 8 is a flowchart showing a processing in a case where re-authentication between devices is executed according to the first embodiment;

FIG. 9 is an illustration showing a system configuration of an information processing apparatus according to a second embodiment of the present invention according to the first embodiment;

FIG. 10 is a flowchart showing a method of controlling the information processing apparatus according to the second embodiment of the present invention according to the first embodiment;

FIG. 11 is an illustration showing a system configuration of an information processing apparatus according to a third embodiment of the present invention according to the first embodiment;

FIG. 12 is a flowchart showing a method of controlling the information processing apparatus according to the third embodiment of the present invention according to the first embodiment;

FIG. 13 is an illustration showing a system configuration of an information processing apparatus according to a fourth embodiment of the present invention according to the first embodiment; and

FIG. 14 is a flowchart showing a method of controlling the information processing apparatus according to the fourth embodiment of the present invention according to a second embodiment of the invention.

### DETAILED DESCRIPTION

Various embodiments according to the invention will be described hereinafter with reference to the accompanying drawings. In general, according to one embodiment of the invention, an information processing apparatus includes a first device and a second device connected by a serial bus interface. The apparatus comprises monitoring means for monitoring packet data to be transmitted and received between the first and second devices, and encryption and decryption means for encrypting and decrypting the packet data. If the monitoring means determines that the packet data to be transmitted and received between the first and second devices is TLP, the packet data are encrypted and decrypted by the encryption and decryption means and then transmitted and received.

### First Embodiment

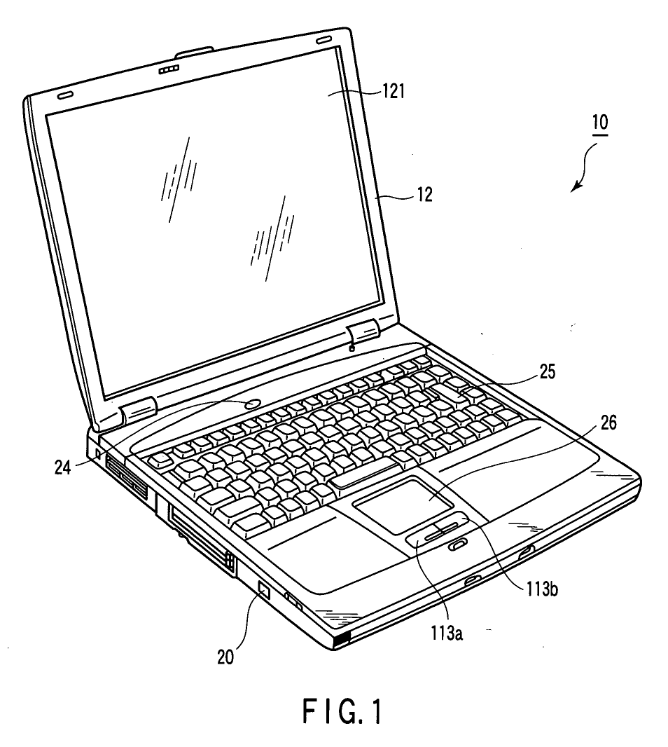

FIG. 1 shows an information processing apparatus according to a first embodiment of the present invention. This information processing apparatus is implemented as a notebook-size computer 10 which can be operated with a battery.

As shown in FIG. 1, the computer 10 is composed of a computer body and a display unit 12. A display device of LCD (Liquid Crystal Display) is incorporated in the display unit 12. A display screen 121 of the LCD is substantially centered on the display unit 12.

The display unit 12 is attached to the computer 10 so as to freely pivot between an opened position and a closed position. The main body of the computer 10 is a housing shaped in a thin box. A power button 24, an LED display unit (display means) 220, and a keyboard 25 are arranged on a top surface of the main body. A touch pad 26, two buttons 113a, 113b and the like are arranged on a palm rest of the main body.

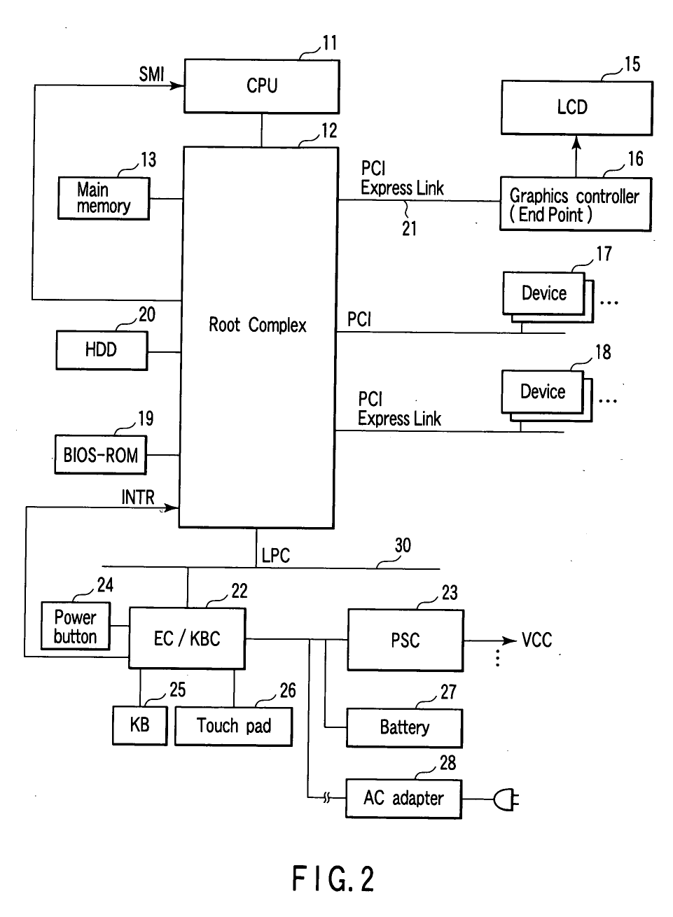

FIG. 2 is a block diagram showing a system configuration of the computer 10.

The computer 10 comprises a built-in battery 27. When the computer 10 is not connected to an external power supply (AC power supply), the computer 10 is operated with the power of the built-in battery 27. When the computer 10 is connected to an AC adaptor 28, i.e. an external power supply (AC power supply), the computer 10 is operated by the external power supply (AC power supply). In addition, the battery 27 is charged by the external power supply.

As shown in the figure, the computer 10 comprises a CPU (Central Processing Unit) 11, a Root Complex 12, a main memory 13, a display device (LCD) 15, a graphics controller (End Point) 16, a PCI (Peripheral Component Interconnect) device group 17, a PCI Express device group 18, a BIOS-ROM 19, a hard disk drive (HDD) 20, an embedded controller/keyboard controller IC (EC/KBC) 22, a power supply controller (PSC) 23, a keyboard (KB) 25, a touch pad 26 and the like.

The Root Complex 12, the graphics controller (End Point) 16 and the PCI Express device group 18 are devices (components) based on the PCI Express standard. Communications between the Root Complex 12 and the graphics controller (End Point) 16 are executed via a PCI Express Link 21 arranged between the Root Complex 12 and the graphics controller (End Point) 16. The PCI Express Link 21 is a communication path composed of a serial interface, including an upstream lane and a downstream lane.

The CPU 11 is a processor for controlling the operations of the computer, executing various kinds of programs (operating system and application programs) loaded into the main memory 13 by the HDD 20. The CPU 11 also executes the BIOS (Basic Input Output System) stored in the BIOS-ROM 19. The BIOS is a program for controlling the hardware. The BIOS also has SMI (System Management Interrupt) routine for dynamically permitting or prohibiting execution of Active State Power Management (ASPM) function defined by the PCI Express standard, in accordance with the operation mode of the computer. As described above, even if the device corresponding to the PCI Express standard is in an operated state (D0 state), the ASPM function can set the Link connected to the device in the low power state (standby state). Each of two devices interconnected via the Link has the ASPM function and can urge the Link state to shift between the operated state and the standby state in which power consumption is lower than that in the operated state, in accordance with whether the Link is in the idle state. This shift is automatically executed by the hardware.

The Root Complex 12 is a bridge device for making connection between a local bus of the CPU 11 and the graphics controller (End Point) 16. The Root Complex 12 also has a function of carrying out communications with the graphics controller (End Point) 16 via the PCI Express Link 21.

The graphics controller (End Point) 16 is a display controller for controlling the LCD 15 employed as a display monitor of the computer.

The embedded controller/keyboard controller IC (EC/KBC) 22 is a one-chip microcomputer in which an embedded controller for power management and a keyboard controller for controlling the keyboard (KB) 25 and the touch pad 26 are integrated. The embedded controller/keyboard controller IC (EC/KBC) 22 has a function of turning on/off the power of the computer 10, in cooperation with the power supply controller (PSC) 23, in accordance with user operations of the power button 24. The embedded controller/keyboard controller IC (EC/KBC) 22 also has a function of detecting connection of the AC adaptor 28 to the computer and detachment of the AC adaptor 28 from the computer. When an event of connecting or detaching the AC adaptor 28 occurs, the embedded controller/keyboard controller IC (EC/KBC) 22 generates an interrupt signal (INTR) to notify the BIOS of the occurrence of the power management event. In response to the interrupt signal (INTR), the Root Complex 12 generates an interrupt signal (SMI) to the CPU 11. In response to the SMI, the CPU 11 executes the SMI routine of the BIOS. The SMI may be directly supplied from the EC/KBC 22 to the CPU 11.

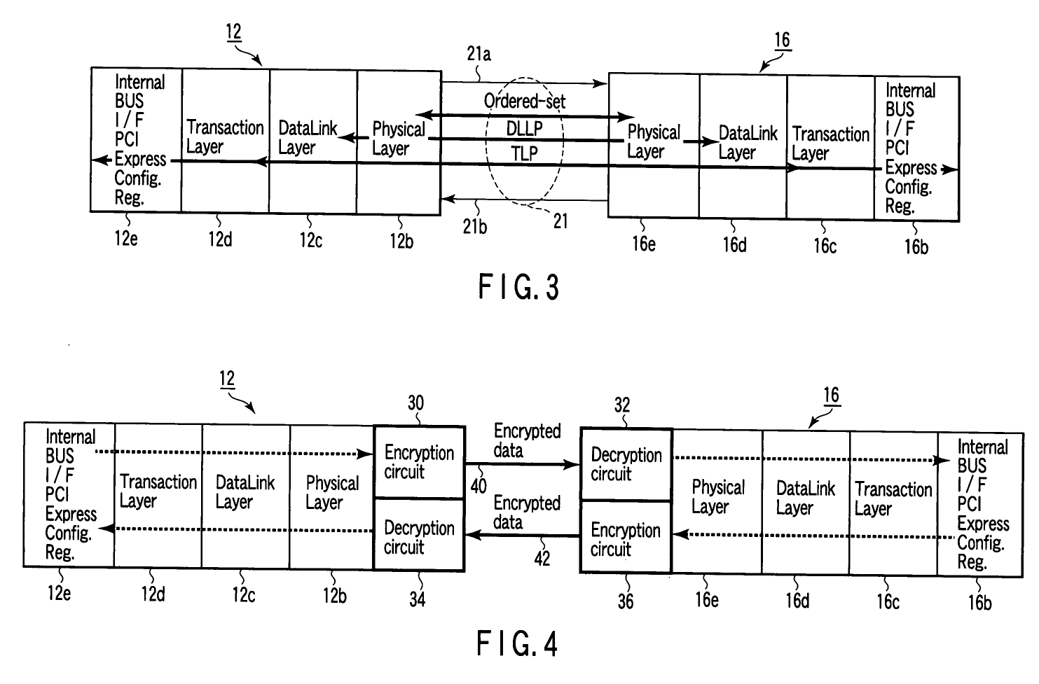

FIG. 3 illustrates connection between two devices based on the PCI Express standard. An example of the connection between the Root Complex 12 (first device) and the graphics controller (End Point) 16 (second device) is explained here.

Data are exchanged between the connected devices by transmitting and receiving packets defined by the format standard. The packets can be roughly classified into three kinds:

Ordered-set for transmission and reception to manage and control the physical connection between Physical layers;

DLLP (Datalink Layer Packet) for transmission and reception to assure data integrity between Datalink Layers; and

TLP (Transaction Layer Packet) for transmission and reception of the data between the devices.

The Root Complex 12 and the graphics controller (End Point) 16 are interconnected via the PCI Express Link 21. The PCI Express Link 21 is a serial interface (serial bus) for making a point-to-point connection between the Root Complex 12 and the graphics controller (End Point) 16. The PCI Express Link 21 includes a differential signal line pair 21a for transmitting information from the Root Complex 12 to the graphics controller (End Point) 16, a differential signal line pair 21b for transmitting information from the graphics controller (End Point) 16 to the Root Complex 12, the Ordered-set for allowing data transmission and reception between Physical layers 12b and 16e, DLLP for allowing data transmission and reception between Datalink Layers 12c and 16d, TLP for allowing data transmission and reception between Transaction BUS I/F 12d and 16c and between Internal BUS I/F, and Internal BUS I/F 12e and 16b. The information transmission between the Root Complex 12 and the graphics controller (End Point) 16 via the PCI Express Link 21 is executed by using packets.

The Ordered-set and the DLLP are used for local communications between the devices. These two packets cannot be added to data which the user arbitrarily sets, and their data formats are strictly defined by the PCI Express standard. Data payload to be added inside the packets is not defined except data length. For this reason, a third party can easily recognize contents stored in the data payload, in the physical lane. Data security is not defined by the current PCI Express standard.

For this reason, the present invention further comprises encryption/decryption means. In other words, the present invention comprises an encryption circuit 30 and a decryption circuit 34 in the Root Complex 12 and an encryption circuit 36 and a decryption circuit 32 in the graphics controller (End Point) 16, as shown in FIG. 4.

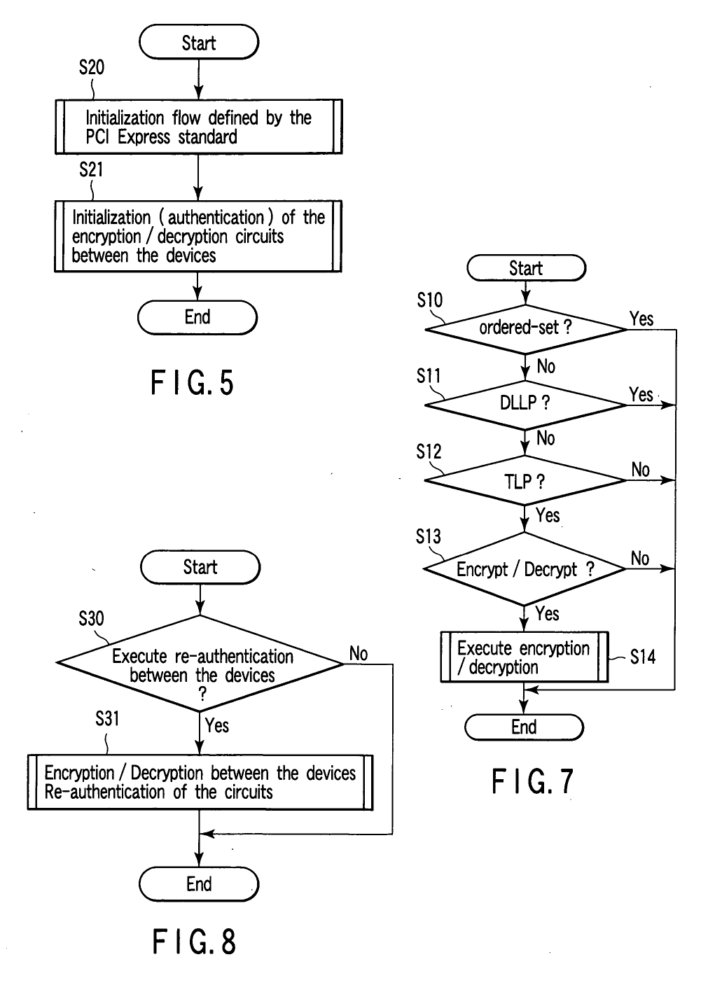

A method of controlling the information processing apparatus according to the first embodiment of the present invention having the above-described structure will be explained with reference to FIG. 5 to FIG. 7.

FIG. 5 is a flowchart showing a processing for initializing authentication of the encryption/decryption circuits 30, 32, 34 and 36.

If the devices are connected to each other, an initialization flow defined by the PCI Express standard is first executed in each of the devices in step S20. A communication path is thereby established between the devices. Next, a processing for validating the encryption/decryption circuits 30, 32, 34 and 36 incorporated in the present invention is executed. In other words, the encryption/decryption circuits 30, 32, 34 and 36 for executing encryption and decryption between the devices are initialized in each of the devices, in step S21.

The initialization is automatically processed by hardware incorporated without intervention of host software, and is executed while the software continues automatically detecting that the initialization based on the PCI Express standard is completed. After completion of the initialization of the encryption/decryption circuits 30, 32, 34 and 36, the host software is notified of the completion. Thus, the initialization of authentication of the encryption/decryption circuits 30, 32, 34 and 36 is ended.

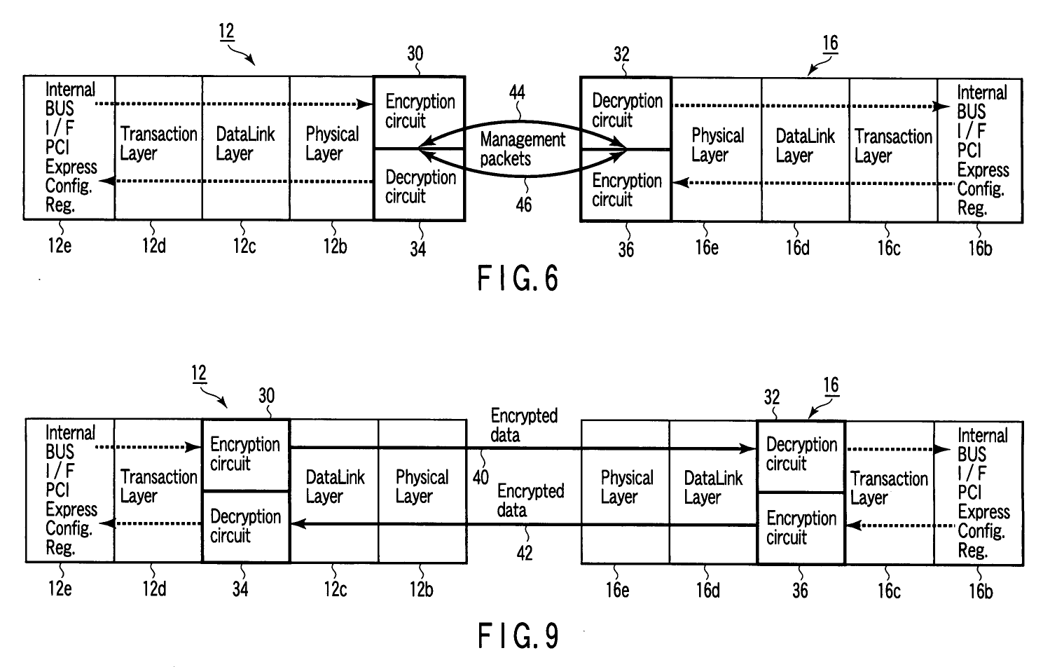

Next, FIG. 6 is an illustration showing management packets used for encryption and decryption. Management packets 44 and 46 are used to control an authentication mechanism for validating the encryption/decryption circuits 30, 32, 34 and 36 incorporated in the devices (Root Complex 12 and graphics controller (End Point) 16). The management packets 44 and 46 are not defined by the PCI Express standard, but newly defined to implement a data security mechanism by the present invention.

In the present invention, the management packets are used for the processing for validating the above-described encryption/decryption circuits 30, 32, 34 and 36. In other words, the management packets are used for the communications between the devices at the time of initializing and re-authenticating (to be explained later) the encryption/decryption circuits 30, 32, 34 and 36. The encryption/decryption circuits incorporated in the devices are authenticated by transmitting and receiving the control information and the like between the devices, and a data security mechanism is thereby established.

FIG. 7 is a flowchart showing a processing executed after the authentication of the encryption/decryption circuits 30, 32, 34 and 36 is completed.

When the packets pass through the encryption/decryption circuits 30, 32, 34 and 36, data encryption/decryption is controlled on the basis of the kind of the packets. In step S10, each of the devices determines whether or not the packets passing through the encryption/decryption circuits 30, 32, 34 and 36 are the Ordered-set used for the control of the Physical Layers 12b and 16e. If the packets are the Ordered-set, the packets are not encrypted or decrypted but are allowed to pass through the encryption/decryption circuits since user-defined data payload is not added to the packets. If each of the devices determines that the packets are not the Ordered-set, the device determines whether or not the packets are DLLP in step S11. If the packets are determined to be the DLLP, the packets are not encrypted or decrypted but are allowed to pass through the encryption/decryption circuits since user-defined data payload is not added to the packets. If each of the devices determines that the packets are not the DLLP, the device determines whether or not the packets are TLP in step S12. If the packets are not the TLP, the packets are not encrypted or decrypted but are allowed to pass through the encryption/decryption circuits since user-defined data payload is not added to the packets. If the packets are determined to be the TLP, each data item of Memory Read/Write, I/O Read/Write, Configuration Read/Write, and Message data is encrypted or decrypted by the encryption/decryption circuits 30, 32, 34 and 36.

FIG. 8 is a flowchart showing a processing in a case where re-authentication between devices is executed.

The re-authentication between devices needs to be executed, for some reasons, when the communication path is established between the devices by the initialization, initialization of the data security mechanism is completed and the data security is ensured.

The re-authentication is implemented by transmitting and receiving the newly defined management packets between the devices, similarly to the initialization flow. This processing is also executed automatically by the incorporated hardware.

Each of the devices executes the re-authentication between the devices in step S30. If the re-authentication is executed, each of the devices the re-authentication of the encryption/decryption circuits 30, 32, 34 and 36 in step S31.

The re-authentication is necessary under the following condition:

If re-authentication is executed for every constant period and an encryption algorithm and an encryption/decryption key are updated to ensure the data security between the devices, the communication path becomes unstable. In accordance with execution of reconfiguration (based on the PCI Express standard) of the communication path between the devices, re-authentication needs to be executed.

Thus, the packet data transmitted and received between the devices connected with the serial bus interface can be encrypted.

### Second Embodiment

FIG. 9 shows a system configuration of an information processing apparatus according to a second embodiment of the present invention. Elements like or similar to those disclosed in the first embodiment are denoted by similar reference numbers and are not described in detail here.

The second embodiment is different from the first embodiment in location of the encryption/decryption circuits 30, 32, 34 and 36.

In the second embodiment, the encryption circuit 30 and the decryption circuit 34 of the Root Complex 12 are arranged between the DataLink Layer 12c and the Transaction Layer 12d, and the encryption circuit 36 and the decryption circuit 32 of the graphics controller (End Point) 16 are arranged between the DataLink Layer 16d and the Transaction Layer 16c. In other words, by arranging the encryption circuits and the decryption circuits between the DataLink Layers and the Transaction Layers, it only needs to be determined whether or not the packets passing between the devices are the TLP.

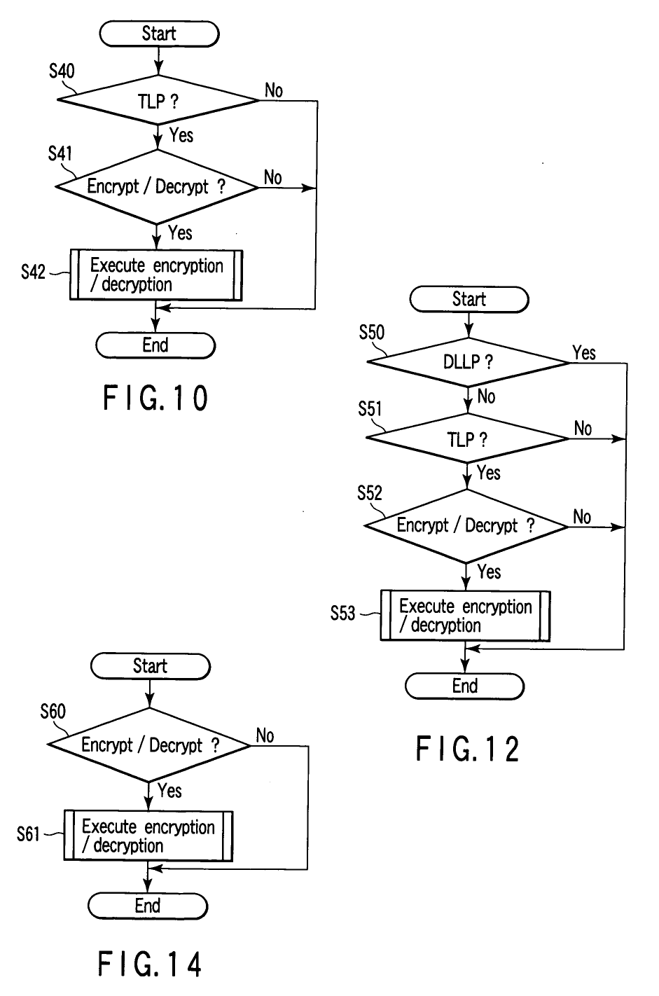

A method of controlling the information processing apparatus according to the second embodiment of the present invention having the above-described configuration will be explained with reference to a flowchart of FIG. 10.

Each of the devices determines whether or not the packets passing between the devices are the TLP, in step S40. If the packets are the TLP, the device determines whether or not the encryption/decryption should be executed, in step S41. If there are not any particular problems, the device executes encryption/decryption in step S42.

Thus, besides the advantage of the first embodiment, it only needs to be determined whether or not the packets passing between the devices are the TLP, by arranging the encryption circuits and the decryption circuits between the DataLink Layers and the Transaction Layers. The processing is thereby simplified.

### Third Embodiment

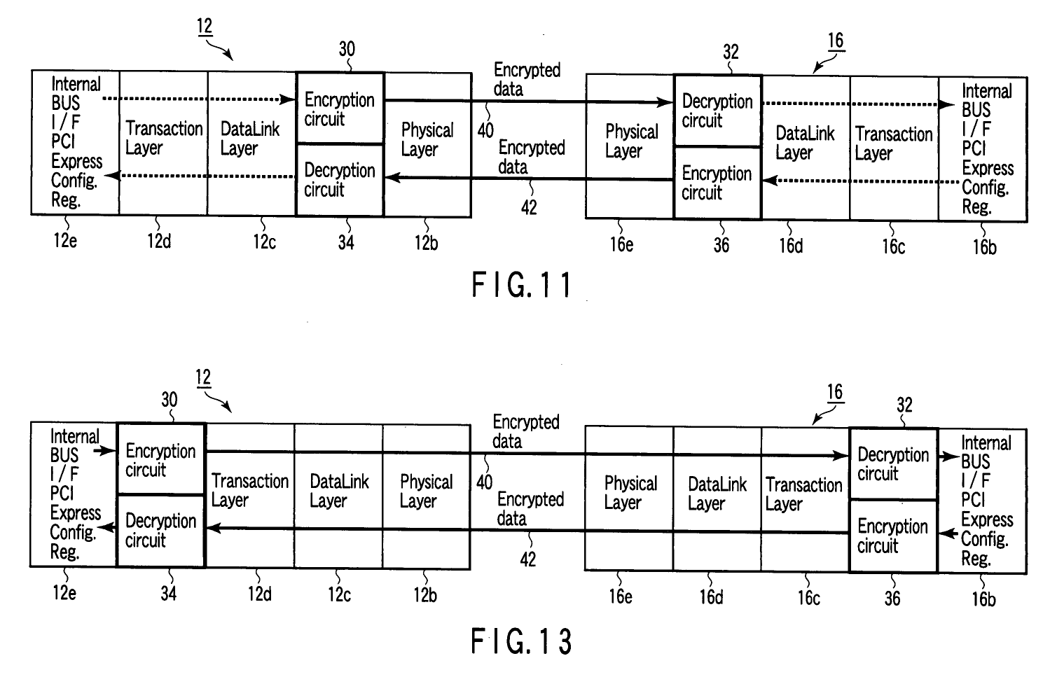

FIG. 11 shows a system configuration of an information processing apparatus according to a third embodiment of the present invention. Elements like or similar to those disclosed in the first embodiment are denoted by similar reference numbers and are not described in detail here.

The third embodiment is different from the first embodiment in location of the encryption/decryption circuits 30, 32, 34 and 36.

In the third embodiment, the encryption circuit 30 and the decryption circuit 34 of the Root Complex 12 are arranged between the DataLink Layer 12c and the Physical Layer 12b, and the encryption circuit 36 and the decryption circuit 32 of the graphics controller (End Point) 16 are arranged between the DataLink Layer 16d and the Physical Layer 16e. In other words, by arranging the encryption circuit and the decryption circuits between the DataLink Layers and the Physical Layers, it only needs to be determined whether or not the packets passing between the devices are the TLP and whether or not the packets are the DLLP.

A method of controlling the information processing apparatus according to the third embodiment of the present invention having the above-described configuration will be explained with reference to a flowchart of FIG. 12.

Each of the devices determines whether or not the packets passing between the devices are the DLLP, in step S50. If the packets are the DLLP, the device determines whether or not the packets passing between the devices are the TLP, in step S51. If the packets are the TLP, the device determines whether or not the encryption/decryption should be executed, in step S52. If there are not any particular problems, the device executes encryption/decryption in step S53.

Thus, besides the advantage of the first embodiment, it only needs to be determined whether or not the packets passing between the devices are the DLLP and whether or not the packets are the TLP, by arranging the encryption circuits and the decryption circuits between the DataLink Layers and the Physical Layers. The processing is thereby simplified.

### Fourth Embodiment

FIG. 13 shows a system configuration of an information processing apparatus according to a fourth embodiment of the present invention. Elements like or similar to those disclosed in the first embodiment are denoted by similar reference numbers and are not described in detail here.

The fourth embodiment is different from the first embodiment in location of the encryption/decryption circuits 30, 32, 34 and 36.

In the fourth embodiment, the encryption circuit 30 and the decryption circuit 34 of the Root Complex 12 are arranged between the Transaction Layer 12d and the Internal BUS I/F 12e, and the encryption circuit 36 and the decryption circuit 32 of the graphics controller (End Point) 16 are arranged between Transaction Layer 16c and the Internal BUS I/F 16b. In other words, by arranging the encryption circuit and the decryption circuits between the Transaction Layers and the Internal BUS I/F, the kind of the packets passing between the devices does not need to be determined.

A method of controlling the information processing apparatus according to the fourth embodiment of the present invention having the above-described configuration will be explained with reference to a flowchart of FIG. 14.

Each of the devices determines whether or not the encryption/decryption should be executed, in step S60. If there are not any particular problems, the device executes encryption/decryption in step S61.

Thus, besides the advantage of the first embodiment, the kind of the packets passing between the devices does not need to be determined, by arranging the encryption circuits and the decryption circuits between the Transaction Layers and the Internal BUS I/F.

According to the present invention, the packet data transmitted and received between the devices connected by a serial bus interface can be encrypted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus including a first device and a second device connected by a serial bus interface, comprising:
monitoring means for monitoring packet data to be transmitted and received between the first and second devices; and
encryption and decryption means for encrypting and decrypting the packet data,
wherein if the monitoring means determines that the packet data to be transmitted and received between the first and second devices is TLP, the packet data are encrypted and decrypted by the encryption and decryption means and then transmitted and received.

2. The apparatus according to claim 1, wherein the encryption and decryption means is arranged outside a physical layer, adjacent to the physical layer, in each of the first and second devices.

3. The apparatus according to claim 1, wherein the encryption and decryption means is arranged between a physical layer and a datalink layer, in each of the first and second devices.

4. The apparatus according to claim 1, wherein the encryption and decryption means is arranged between a datalink layer and a transaction layer, in each of the first and second devices.

5. The apparatus according to claim 1, wherein the encryption and decryption means is arranged between a transaction layer and an internal bus control means, in each of the first and second devices.

6. The apparatus according to claim 1, wherein the serial bus interface corresponds to PCI Express.

7. A method of controlling an information processing apparatus including a first device and a second device connected by a serial bus interface,
wherein the information processing apparatus comprises:
monitoring means for monitoring packet data to be transmitted and received between the first and second devices; and
encryption and decryption means for encrypting and decrypting the packet data, and
wherein if the monitoring means determines that the packet data to be transmitted and received between the first and second devices is TLP, the packet data are encrypted and decrypted by the encryption and decryption means and then transmitted and received.

8. The method according to claim 7, wherein the encryption and decryption means is arranged outside a physical layer, adjacent to the physical layer, in each of the first and second devices.

9. The method according to claim 7, wherein the encryption and decryption means is arranged between a physical layer and a datalink layer, in each of the first and second devices.

10. The method according to claim 7, wherein the encryption and decryption means is arranged between a datalink layer and a transaction layer, in each of the first and second devices.

11. The method according to claim 7, wherein the encryption and decryption means is arranged between a transaction layer and an internal bus control means, in each of the first and second devices.

12. The method according to claim 7, wherein the serial bus interface corresponds to PCI Express.
